(19) United States
(12) Patent Application Publication
(10) Pub. No.: US 2024/0198725 A1
(43) Pub. Date: Jun. 20, 2024

(54) MACHINE AND METHOD FOR AUTOMATIC APPLICATION OF RIM TAPE

(71) Applicant: ORBEA, S.COOP., Mallabia (Bizkaia) (ES)

(72) Inventors: LUIS SERRANO FUENTES, Mallabia (BIZKAIA) (ES); MANUEL MARTÍN GARCÍA, Mallabia (BIZKAIA) (ES); JUAN CARLOS CAMBRONERO GONZÁLEZ, Mallabia (BIZKAIA) (ES); ANTONIO JAVIER CALVO CAMBRONERO, Mallabia (BIZKAIA) (ES)

(21) Appl. No.: 18/539,719

(22) Filed: Dec. 14, 2023

(30) Foreign Application Priority Data
Dec. 19, 2022 (EP) 22383238.7

(51) Int. Cl. B60B 31/00; B60B 21/12

(52) U.S. Cl. CPC B60B 31/005; B60B 21/12

(57) ABSTRACT

The invention refers to a machine (1) and the automatic method for applying tape (5) in the interior of the rim (3a) of a bicycle wheel (3) to protect the inner tube and/or seal the rim (3a) for tubeless tyres. The machine (1) of the invention comprises a stand (2) where the wheel (3) is placed on a positioning and retention system (4) that rotates it to place the tape (5) in the interior of the rim (3a) by means of a dispensing system (6). The machine (1) and the method of the invention comprise a shaping system (8) for the tape (5) by means of a pressure roller (8a) and a heat dispenser (8b) together with an automation system (9) to setting the taping parameters required by the different systems.

### FIELD OF THE INVENTION

The invention relates to an automatic rim-tape application machine for bicycle wheels and to the automatic method of applying the rim tape.

### PRIOR ART

Rim tape is an essential element for protecting the inner tube inside the tyre on a bicycle wheel to prevent direct contact with the spokes, which can cause unwanted punctures. In these cases, the rim tape is usually made of rubber as well as being elastic and having adhesive backing to aid installation.

Currently, bicycle wheels without an air inner tube, known as tubeless, are also known, where the tyre is sealed directly onto the rim. In this type of wheel, the rim tape is an adhesive tape that is installed manually and must be well sealed. However, the installation of this type of rim tape requires very careful and exhaustive placing, with a lot of pressure in the various turns that are given to the rim, so that it is a very difficult process to carry out manually if one wants to guarantee a good sealing and tightness.

Due to the precision required by the work of applying the adhesive tape, generally done manually, there are currently several systems or devices, such as that described in patent CN211563778U, to speed up and facilitate the work.

The utility model CN211563778U describes an electrically operated machine for sticking adhesive rim tape on a rim. The steel rim is placed vertically and/or axially and positioned inside the device, and at the top of the rim there is a rubber pressure roller that presses the tape onto the rim. Once the tape has been put into position, the device is also able to cut it off, although in a way that is not specified. The described device comprises control knobs that start and stop the machine. However, it is possible that a wheel finished using this machine may be far from perfect in terms of not being tightness or sealing enough of the groove of the rim for the correct assembly of tubeless tyres.

Due to all of the above, the objective of the invention is to provide a rim-tape application machine that performs the taping and sealing process of the rim tape in an improved way, and the automatic method to prevent wrist injuries that operators may suffer when applying rim tape.

### BRIEF DESCRIPTION OF THE INVENTION

The object of the invention is an automatic rim-tape application machine and a semi-automatic rim-tape application method using the machine of the invention. Therefore, this is a description of a machine that distributes, places, fixes and moulds a tape to the interior of the rim to protect the inner tube and the seal of a bicycle tyre.

The rim-tape application machine of the invention comprises a stand where a wheel is placed on a frontal surface, which is fixed by means of a positioning and retention system located around the wheel. The positioning and retention system comprises at least one roller that allows the wheel to rotate to place a tape at the bottom of the rim. The tape used, which is preferably self-adhesive and high performance, is fixed to the interior of the wheel rim by means of a tape dispensing system, while the positioning and retention system rotates the wheel. Once the tape has been placed on the interior of the rim, an automatic cutting system in the dispensing system cuts the tape.

However, the machine of the invention is characterized by the fact that it comprises a shaping system that comprises at least one mobile pressure roller and a heat dispenser focused towards the wheel, so that the pressure roller exerts pressure on the tape that a moment before has been heated up, achieving high-quality shaping and sealing of the tape and making the rim valid for tubeless tyres also.

In addition, the machine is automatic, as it includes an automation system to programme all the parameters of the taping process. In other words, thanks to the automation system, the placing of the rim tape is carried out automatically depending on the system configuration, which is in charge of managing and sending the operating order automatically to all the machine systems. As a result, the automation system is connected to the positioning and retention system, the dispensing system, the cutting system and the shaping system.

The automatic method of the invention for placing the rim tape comprises steps where the machine of the invention is activated to rotate a wheel and place a tape on the bottom of a bicycle rim. However, the method of the invention is characterized by the fact that it comprises the activation steps of a shaping system, where heat is projected onto the wheel by means of a heat dispenser and subsequently the tape is pressed by means of a pressure roller onto the interior of the wheel rim.

Due to all of the above, the machine of the invention manages to place the tape on the rim of a bicycle wheel by means of a fully automatic operation of the machine quickly and precisely, by means of the quick programming of the machine. In addition, it is possible to optimise the results with perfect placement of the tape thanks to the use of heat for fixing and moulding, minimizing the manual efforts needed by the operators, so that highly qualified personnel are not required. This gives a seal that meets the requirements of protecting the inner tube of a tyre and/or making the wheel suitable for a tubeless tyre.

### BRIEF DESCRIPTION OF THE FIGURES

The details of the invention can be seen in the accompanying figures, not to be considered limiting of its scope:

FIG. 1A shows a front view of the machine (1) for applying the rim tape of the invention in operational mode.

FIG. 1B shows a front view of the machine (1) for applying the rim tape of the invention in resting mode.

FIG. 2 shows a profile view of the machine (1) of FIG. 1.

FIG. 3 shows a rear perspective of the machine (1) of FIG. 1 without its cover (2c).

FIG. 4 shows a detailed front view of the dispensing system (6) of the machine (1) of the invention.

FIG. 5 shows a detailed front view of the shaping system (8) of the machine (1) of the invention.

FIG. 6 shows a rear perspective view in detail, of the dispensing system (6) and of the hole punch (11) of the machine (1) of FIG. 3.

FIG. 7 shows a perspective of an embodiment of the machine (1) in the situation of FIG. 1B with safety bars (13).

### DETAILED DESCRIPTION OF THE INVENTION

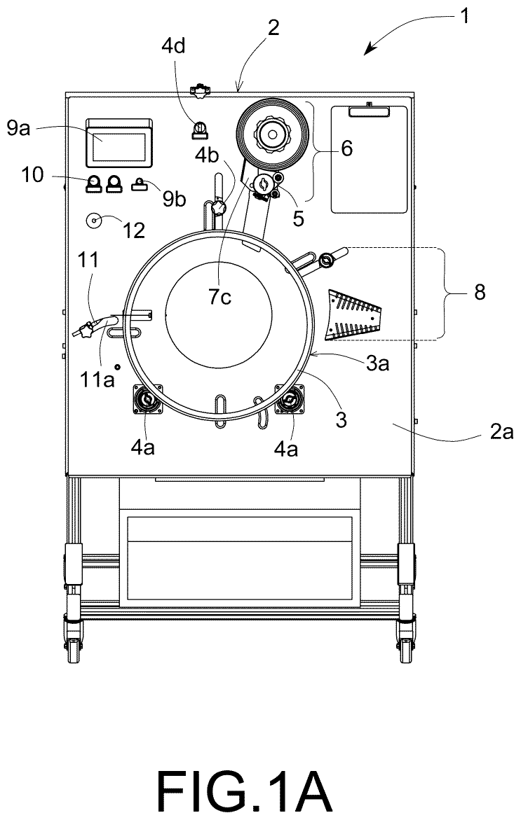

The invention refers to a machine (1) for the automatic application of a rim tape onto a wheel rim (3a) like the one shown in FIGS. 1 to 3. That is, a machine (1) that applies, for example, self-adhesive tape (5) to the interior of the rim (3a) of a wheel (3) to protect the inner tube and/or seal the rim (3a) to later place a tyre on the wheel (3) of a bicycle.

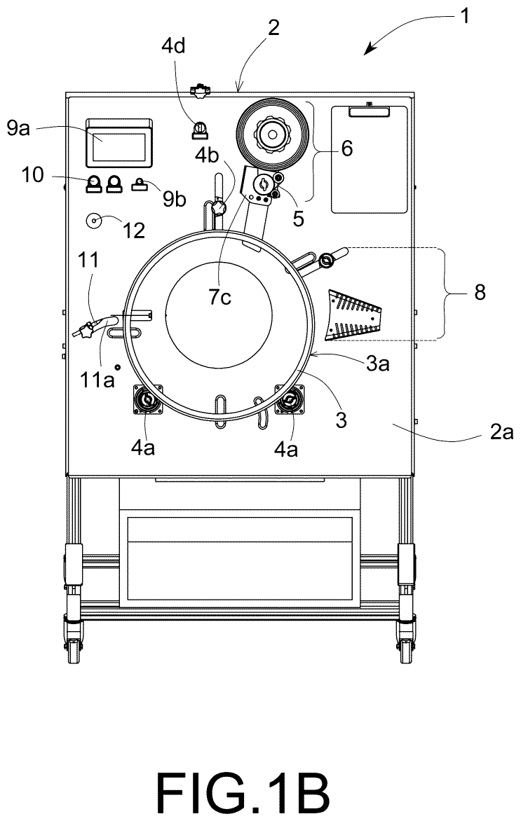

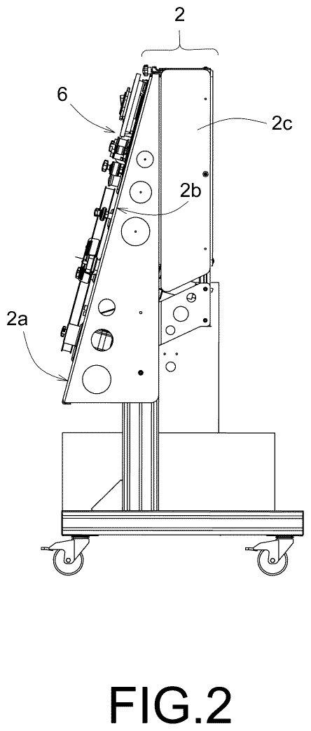

The machine (1) of the invention comprises a stand (2) with a front surface (2a) where the wheel (3) is placed and a rear surface (2b) that has a cover (2c) that protects some systems forming part of the machine (1) as shown in FIGS. 2 and 3. Specifically, the wheel (3) is placed on at least two fixed rollers (4a) on the lower part of the stand (2) and at least one mobile roller (4b) on the upper part of the stand (2), which form a positioning and retention system (4) for the wheel (3). The mobile roller (4b) is moved by a longitudinal guide (4c), which allows the user to adjust the positioning and retention system (4) to different diameters of wheel (3). When the wheel (3) is placed and the movable roller (4b) is adjusted to the diameter of the wheel (3), it can be seen that on the movable roller (4b) there is a locking button (4d) to lock the movement of the mobile roller (4b) in the longitudinal guide (4c). As a result, after the retention of the mobile roller (4b), the wheel (3) can only rotate due to friction from the rotation of the fixed rollers (4a) and the pressure of the rollers (4a, 4b) on the edge of the rim (3a) since the rollers (4a, 4b) are slightly thicker than the width of the rim (3a).

As shown in FIGS. 1A to 3 and 7, the stand (2) of the machine (1) of the invention comprises an inclined front surface (2a) that improves operator ergonomics and minimizes work injuries. In addition, it includes at least four wheels at the bottom of the stand (2) to make it easy to move from one place to another.

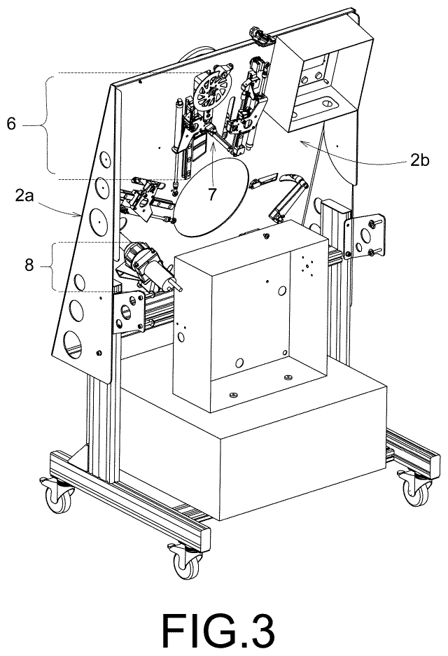

As can also be seen in FIGS. 1A and 1B and in more detail in FIG. 4, on the front surface (2a), specifically above the wheel (3) and the mobile roller (4b), there is a mobile tape (5) dispensing system (6). In other words, the dispensing system (6) can move along a radial guide (6g) fixed to a base of the rear surface (2b) of the stand (2), parallel to a guide groove (6c) on the stand (2) from a resting position on the upper part of the stand (2) until it comes into contact with the wheel (3). The dispensing system (6) comprises a roll (6a) of tape (5) placed and fixed on an axle (6h) attached to a tensing system (6b) that is located between the wheel (3) and the roll (6a) on the front surface (2a) of the stand (2). The tensing system (6b) of the dispensing system (6) comprises at least three rollers, where at least one tensing roller (6e) has a larger diameter than the other two guide rollers (6f). In other words, the larger diameter tensing roller (6e) will have the purpose of generating tension in the tape (5) to prevent wrinkles and the smaller diameter guide rollers (6f) above and below the tensing roller (6e) are for directing the tape (5) towards the inside of the rim (3a). The tensing roller (6e) that is in contact with the inside of the rim (3a) has the same thickness as the width of the inside of the rim (3a) in order to be inserted into it and fix the tape (5) completely flat. In addition, the dispensing system (6) is capable of moving along the radial guide (6g) and the guide groove (6c) from a resting position until it meets the wheel (3) when activated by a start button (10) on the upper part of the stand (2).

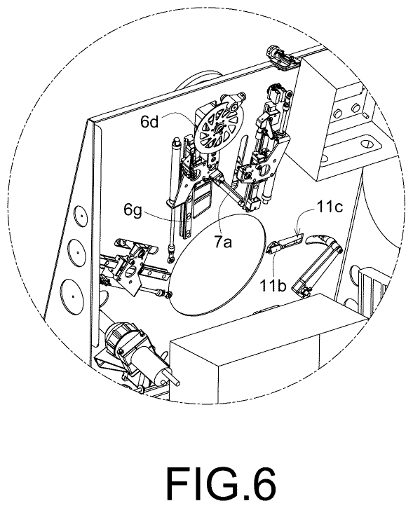

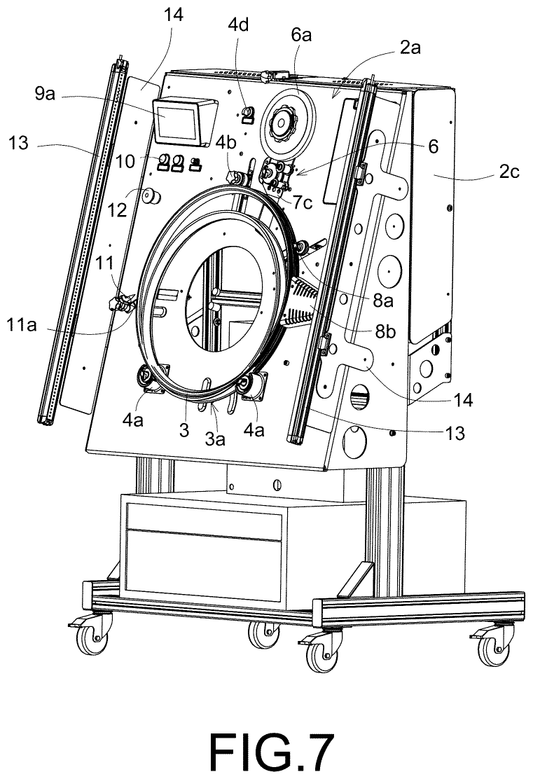

In addition, the dispensing system (6) also comprises a retention system (6d) formed, for example, of a brake disc installed on a rear surface (2b) of the stand (2) connected to the dispensing system (6) to exert a certain dosed retention on the axle (6h) of the roll (6a) as shown in FIGS. 3 and 6. The tape (5) is also placed in the interior of the rim (3a) with the right tension to stick it as strongly and smoothly as possible. This retention system (6d) also has a regulation device to establish the necessary tension of the tape (5). As also shown in FIGS. 1A, 3 and 4, the dispensing system (6) is also connected to a mobile, displaceable cutting system (7) next to the dispensing system (6), since once the necessary tape (5) has been fixed to the interior of the rim (3a), the tape (5) must be cut. To do so, the cutting system (7) comprises a protector (7c) that is located on the front surface (2a) as shown in FIGS. 1A, 1B and 7, behind which there is a blade (7b) attached to a pneumatic piston (7a) located on the rear surface (2b) of the stand (2). The pneumatic piston (7a) moves the blade (7b) perpendicularly, so that the blade (7b) passes through the stand (2) from the rear surface (2b) towards the front surface (2a) through a lower area of the guide groove (6c). The protector (7c) is for protecting the blade (7b) when it is necessary for the operator to handle the roll (6a) for its replacement or when the machine (1) is not in operation. In other words, the protector (7c) can be moved from a resting position as shown in FIG. 1A, where the blade (7b) is exposed when the machine (1) is in operation, to a protective position shown in FIG. 1B, where the blade (7b) is covered by the front surface (2a), shows when the machine (1) is not operating or the roll (6a) must be replaced. In the preferred embodiment of the invention, the protector (7c) comprises a C-shaped flat body that, together with the axle (6h), limits the movement of the protector (7c).

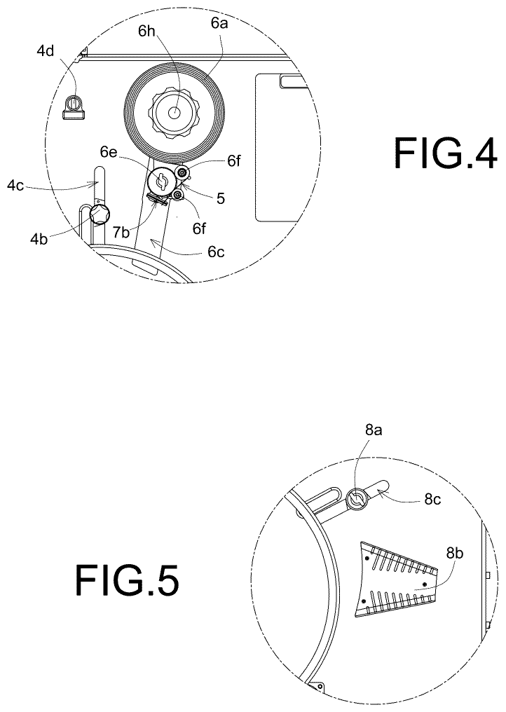

Furthermore, the machine (1) of the invention, as can be seen in FIG. 5, is characterized in that in a lateral area of the stand (2) there is a shaping system (8) that comprises at least one pressure roller (8a) that is laterally displaceable by a lateral guide (8c), from a resting position at an outer end of the lateral guide (8c) of the stand (2) towards an active position in contact with the interior of the rim (3a) and a heat dispenser (8b) on the front surface (2a) oriented to dispense heat towards the wheel (3). By means of this shaping system (8) and once the tape (5) is placed on the interior of the rim (3a), heat is applied by means of the heat dispenser (8b) and pressure with the pressure roller (8a), achieving the regular shape of the tape (5), and thus eliminating bubbles so that it is completely adhered and matched, i.e., that the seal is tight and guarantees the necessary tightness for the assembly of the tyre or tubeless tyre. To do this, the pressure roller (8a) must have a thickness and shape equal to the interior of the rim (3a) so it must be exchangeable depending on the wheel (3) to be taped.

Next, as FIGS. 1A and 1B and FIG. 6 show in detail, on the other side of the wheel (3), that is, on the opposite side to the shaping system (8), the stand (2) comprises a hole punch (11) which can be moved along a guide (11a) and oriented by means of a laser (11b) designed to mark a hole for a valve of the wheel (3) so that the punch (11) moves and make a hole for the valve of the wheel (3) on the tape (5). Specifically, the laser (11b) is located on the rear surface (2b) of the stand (2) at the height of the hole punch (11) and oriented towards the hole punch (11) and a slot (11c) on the stand (2) that makes it possible to project a light on the rim (3a) between the hole punch (11) and the slot (11c).

In addition, as previously mentioned, the object of the invention is an automatic machine (1) for applying rim tape. Therefore, the machine (1) includes an automation system (9) whereby it is possible to establish and define the taping parameters necessary to carry out the process of placing the tape (5) on the interior of the rim (3a) automatically. As seen in FIGS. 1A and 1B, the stand (2) comprises an automation system (9) in the upper area connected to all the previously mentioned systems by the rear surface (2b) of the stand (2) as shown in FIG. 3. The automation system (9) comprises a display or touch screen (9a) on the front surface (2a) of the stand (2) that is easily accessible to the user, where the user can enter the following parameters:
Taping process;
   Number of complete turns that the wheel (3) will make for the placing of the tape (5)
   Wheel (3) rotation speed
   Length of tape (5) used
   Position of the valve hole (14) to calculate the overlap of the tape (5) on the valve hole (14).
Shaping process:
   Number of complete turns of the wheel (3) that occurs with the pressure roller (8a) applying pressure to the bottom of the rim (3a).
   Turning speed of the wheel (3) while the pressure roller (8a) presses the tape (5).
   Action of the pressure roller (8a).
   Diffusion time and temperature of the heat dispenser (8b)

The touch screen (9a) also allows various different options such as; the option to cancel the activity of the machine (1), to choose the blade (7b) change option, where the cutting system (7) moves towards the front surface (2a) to give the user access to the blade (7b) and the option to preheat, an option necessary to start using the machine (1).

Additionally, and for safety, the machine (1) can include an emergency stop button (12) and an automated system for stopping and resetting the automation system (9) and the machine (1). In alternative embodiments, the machine (1) can also include a protection system by means of sensors to prevent people approaching the perimeter while the machine (1) is in operation. In the preferred embodiment, the protection system consists of safety bars (13) on fixtures (14) on the sides of the front surface (2a) as shown in FIG. 7. The safety bars (13) are a security solution based on emitting beams of light from one bar (13) to another so that if something interrupts the beam of light while the machine (1) is in operation it is detected by means of sensors.

Therefore, the machine (1) of the invention is for taping the rim (3a) of a wheel (3) quickly, easily, conveniently and safely for the operator or user of the machine (1), achieving optimal placement of the tape (5) for the use of tubeless tyres, in a safe way for the operator.

The invention also refers to an automatic method for applying the rim tape by means of the machine (1) of the invention, where the machine (1) is activated to rotate a wheel (3) and place a tape (5) on the interior of the rim (3a). In other words, the tape (5) application method can be fully automatic or semi-automatic, where the steps are carried out fully automated or between an operator and the machine (1). The operator merely has to place the wheel (3), start the machine (1), finish and remove the wheel (3).

Initially, an automation system (9) is configured by means of a touch screen (9a) which is adjustable by means of a control knob (9b). Both elements (9a, 9b) are located in an upper front surface (2a) of the machine (1) and are designed to configure the parameters of the machine (1), such as the number of taping turns, the speed of rotation, the overlapping of the tape (5), the number of turns in the shaping, the temperature of shaping, heat exposure time, etc. depending on the bicycle wheel (3) that needs to be taped.

Next, the wheel (3) is placed in the machine (1) resting on at least two fixed rollers (4a) as indicated by the projection of a laser (11b) on the internal part of the wheel (3), that is to say that a valve hole in the wheel (3) must coincide with the projection of the laser (11b) on the inside of the wheel (3). Once the valve hole is located, the wheel (3) is fixed by means of at least one mobile roller (4b), which can be moved by a longitudinal guide (4c) to adjust it to the diameter of the wheel (3). After fixing the wheel (3) with the movable roller (4b), the locking screw or button (4d) is pressed to block the longitudinal movement of the movable roller (4b).

Once the wheel (3) is fixed, a protector (7c) in the cutting system (7) is raised and at least two motors connected to the fixed rollers (4b), located on the rear surface (2b) of the machine (1), are activated (1), which will start the automation process of the machine (1) systems, by optionally activating a start button (10). That is to say, the fixed rollers (4a) begin to rotate, which by friction make the wheel (3) rotate and the path established for the overlapping parameter of the tape (5) will rotate over the valve hole. Once sufficient turn has been made for the overlapping of the tape (5), the fixed rollers (4a) stop and a dispensing system (6) moves along a radial guide (6g) of the system (6) thanks to a guide groove (6c) on the stand (2) until a tensing system (6b) in the dispensing system (6), through which the tape (5) protrudes, comes into contact with the wheel (3), specifically with the interior of the rim (3a). In this way, the tape (5) sticks to the interior of the rim (3a) and the fixed rollers (4a) start working again by turning the wheel (3) and sticking the tape (5) without wrinkles and with some tension to the interior of the rim (3a). Once the taping turns established in the automation system (9) have finished, the fixed rollers (4a) stop turning and the dispensing system (6) returns to its starting position, to activate a connected and movable cutting system (7) with the dispensing system (6) on the rear surface (2b) of the stand (2). Therefore, a pneumatic piston (7a) is activated to move a blade (7b) connected to it, from a rear surface (2b) towards a front surface (2a) of the stand (2) through the guide groove (6c) to cut the tape (5) in the area that is under tension between the mobile roller (4b) and the tensing system (6b), which is now in the resting position.

Following the cutting of the tape (5), the rotation of the fixed rollers (4a) is activated again and a shaping system (8) and/or thermal moulding is also activated according to the criteria specified in the automation system (9). In other words, at least one pressure roller (8a) of the shaping system (8) moves along a lateral guide (8c) towards the interior of the rim (3a) to exert pressure on the tape (5) while a heat dispenser (8b) projects hot air onto the belt (5) before reaching the pressure roller (8a). In this way, a better adhesion of the tape (5) to the interior of the rim (3a) is achieved and any imperfection that may have remained during the placement of the rim tape is corrected.

Subsequently, when the tape (5) is correctly fixed on the bottom of the rim (3a), the rotation of the wheel (3) and the fixed rollers (4a) stops. Finally, the mobile roller (4b) is unlocked, releasing the wheel (3) of the machine (1) and the wheel (3) is turned until the valve hole is positioned where the laser projection (11b) indicates. The wheel (3) is locked again by means of the mobile roller (4b) so that, by means of a hole punch (11) that can be moved along a guide (11a) that is located on the opposite side of the shaping system (8), the hole is made in the tape (5) for the valve. Once the valve hole has been punched, the mobile roller (4b) is unlocked again, releasing the wheel (3) from the machine (1).

Due to all of the above, an automatic operating machine (1) is achieved for taping the interior of the rim (3a) of a bicycle wheel (3) and a very simple semi-automatic procedure, thanks to which the effort of placing the tape (5) and the results of the taping are optimized thanks to the dispensing (6) and shaping systems (8). In addition, the parameterization of the automation system (9) for different wheels (3) is dynamic and easy to use thanks to the touch screen (9a) and the many possibilities it offers.

1. Automatic rim tape application machine where a wheel is placed on a stand and is fixed by means of a positioning and retention system that allows the wheel to rotate to place tape in the interior of the rim by means of a tape dispenser system where the machine is characterized by comprising:
A shaping system for the tape comprising at least one heat dispenser facing the wheel and at least one pressure roller that can be moved towards the interior of the rim.

2. Machine for applying rim tape, according to claim 1, where the machine comprises a automation system for the setting of the taping parameters that includes a touch screen and is connected to the positioning and retention system, to the dispensing system, to a cutting system and to the shaping system.

3. Machine for applying rim tape, according to claim 1, where the positioning and retention system comprises at least two fixed rollers in a lower part of the stand under the wheel and at least one mobile roller movable by a longitudinal guide in an upper part of the stand above the wheel.

4. Machine for applying rim tape, according to claim 1, where the dispensing system is located in an upper part of the stand parallel to the mobile roller and comprises a roll of tape attached to a tensing system, which comprises at least three rollers, with at least one having a larger diameter than the others, located between the wheel and the roll and a retention system on a rear surface of the stand connected to an axle of the roll of tape.

5. Machine for applying rim tape, according to claim 1, where the dispensing system can be moved by a guide groove parallel to a longitudinal guide from a resting position in the upper part of a front surface toward a contact position with the wheel.

6. Machine for applying rim tape, according to claim 1, where the dispensing system is connected to a cutting system comprising a pneumatic piston on a rear surface of the stand that is attached to a blade.

7. Machine for applying rim tape, according to claim 1, where at least one pressure roller of the shaping system can be moved laterally by a lateral guide, from a resting position at one outer end of a front surface of the stand towards an active position in contact with the interior of the rim.

8. Machine for applying rim tape, according to claim 7, where the pressure roller is interchangeable according to the wheel model and dimensions, shape or size of the rim.

9. Machine for applying rim tape, according to claim 1, where the machine comprises a hole punch that can be moved along a guide towards a projection laser.

10. Machine for applying rim tape, according to claim 1, where the machine comprises a protection system by means of sensors.

11. Automatic method for placing rim tape, where the machine is activated to rotate a wheel and place tape on the interior of a rim, where the procedure includes the steps of:
Activating a shaping system,
Projecting heat on the tape of the wheel using a heat dispenser,
Pressing a pressure roller above the tape on the interior of the rim.

12. Automatic method for placing rim tape, according to claim 10, comprising the previous steps of:
Setting an automation system, according to some taping parameters of the rim tape,
Placing the wheel on the positioning and retention system,
Fixing the wheel using a laser projection that indicates the position of a valve hole.

13. Automatic method for placing rim tape, according to claim 10, comprising the additional steps of:
Moving a tape dispenser system until it comes into contact with the wheel,
Sticking the tape in the interior of the rim,
Turning the wheel sticking the tape for the established turns,
Activating a cutting system in the dispensing system, activating a blade towards the tape,
Cutting the tape.

14. Automatic method for placing rim tape, according to claim 12, wherein the activation of the dispensing system comprises the additional steps of:
Adjusting a retention system located at the rear surface of the stand, to slow the axle of the roll of the dispensing system and tighten the tape during the placement of the tape to ensure even adhesion.

15. Automatic method for placing a rim tape, according to claim 10, comprising the subsequent steps of:
Turning the wheel to place a valve hole where a laser projection indicates,
Blocking the wheel by means of the mobile roller,
Moving a hole punch through a guide to make a hole for the valve in the tape,
Releasing the wheel.
